(19) United States
(12) Patent Application Publication
(10) Pub. No.: US 2004/0217984 A1
(43) Pub. Date: Nov. 4, 2004

(54) Digital imaging system

(76) Inventor: George R. Borden IV, Portland, OR (US)

Correspondence Address: Kevin L. Russell, Suite 1600, 601 SW Second Ave., Portland, OR, 97204-3157, US

(21) Appl. No.: 09/823,219

(22) Filed: Mar. 29, 2001

(51) Int. Cl. H04N 5/76; H04N 5/262; H04N 5/222

(52) U.S. Cl. 345/723; 348/239; 348/333.05

(57) ABSTRACT

A digital imaging system for using digital image and video content.

### BACKGROUND OF THE INVENTION

The present invention relates to a digital imaging system.

Digital images are obtained from a variety of sources, such as from an image scanning system, a digital camera, and a camcorder (digital and/or film). The resulting digital images are used for numerous purposes, such as for example, digital video, web based images, and photographic quality prints.

The digital images are typically stored on a write once storage medium or re-writeable storage medium, such as a computer hard drive, a tape, a compact disk, a digital video disk, an optical disk, etc. In addition, multiple images may be stored on the storage medium, thereby creating an archive.

To modify the digital images, the digital images are loaded into the memory of a computer system and thereafter modified using appropriate digital image editing software, such as Photoshop available from Adobe or EditStudio available from Pure Motion, Ltd. After modification of the digital images, the modified digital images are typically stored on a storage medium.

To view the digital images, the digital images are loaded into the memory of a computer system or other type of viewer. Similarly, a browser or other imaging system may be used to search for and view a single image or multiple images. The viewed images may overwrite the existing image file on the storage medium after viewing.

Further, digital image management software may be used to keep track of different images, such as where a digital image is stored, who has revised the digital image, the type of available digital images, etc.

### BRIEF DESCRIPTION OF THE DRAWINGS

FIG. 1 is a block diagram of un-compressing and re-compressing a lossy JPEG image.

FIG. 2 is a block diagram of un-compressing a lossy JPEG image and -recompressing a lossy GIF image.

FIG. 3 is a block diagram of modifying an image file for viewing.

FIG. 4 is a block diagram of modifying an image file for different applications, such as storage, editing, or viewing.

FIG. 5 is an exemplary block diagram of a digital image and video content management system of the present invention.

### DETAILED DESCRIPTION OF THE PREFERRED EMBODIMENT

The present inventor came to the striking realization that after extended viewing, storing, and editing digital images the image quality became increasing more degraded. After further consideration of the unexpected image quality derogation the present inventor determined that the principal source of the image quality derogation is the modification of the image file itself between different applications.

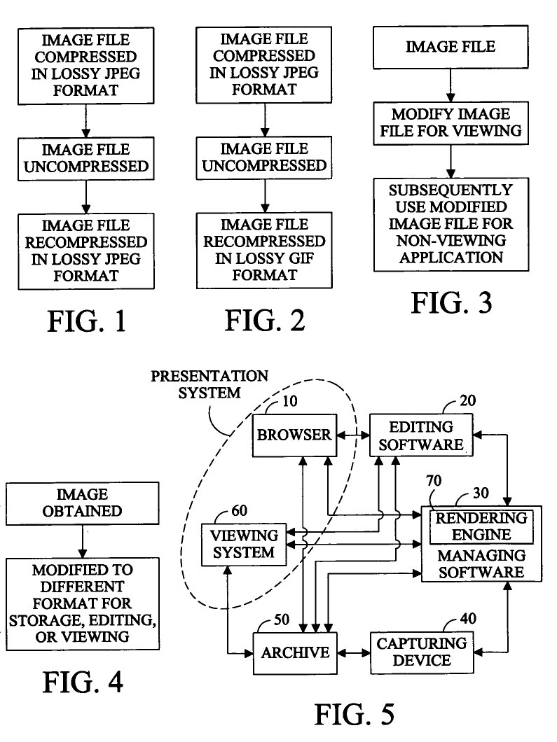

Referring to FIG. 1, for example, if a digital image file is compressed in a lossy JPEG format, uncompressed and possibly modified, and recompressed in a lossy JPEG format, then the resulting image quality will be degraded by the un-compression and re-compression of the lossy JPEG format image file.

Referring to FIG. 2, for example, further if a digital image file is compressed in a lossy JPEG format, uncompressed and possibly modified, and recompressed in a lossy GIF format, then the resulting image quality will be degraded by the un-compression and re-compression of the lossy JPEG and GIF format image files.

Referring to FIG. 3, for example, also if the image is viewed by a image viewing device the image file is normally modified for optimal viewing for the particular image viewing device. Thereafter, if the modified image file is subsequently used for further image processing or otherwise used for other applications, the resulting image quality will be degraded because of the previous optimization for viewing.

Referring to FIG. 4, for example, if the image is captured or otherwise obtained in an initial format and thereafter modified to a different format for storage, modified for viewing, modified for editing, or otherwise modified, then the modifications will result in a derogation of the quality of the digital image.

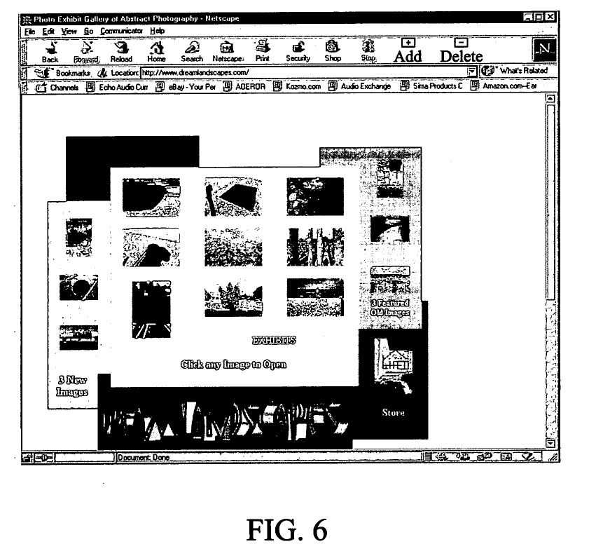

Referring to FIG. 5, an exemplary image processing system includes a browser 10, editing software 20, managing software 30, capturing device 40, an archive 50, and a viewing system 60. The capturing device 40 may be any suitable device for obtaining a digital image or digital video. The digital image or video may originate from a variety of sources, such as for example, from an image scanning system, a digital camera, and a camcorder (digital and/or film). Also, the capturing device 40 may be a stream of video, such as video from a computer hard drive or other source. Further the capturing device 40 include a twain or other interface to provide a digital image or video. The capturing device 40 obtains or otherwise provides a digital image or video in a particular file format.

The managing software 30 receives or otherwise keeps track of each of the digital images and video content. The tracking may include tracking copies of the digital images and video content stored in memory, saved in one or more files, or otherwise used by other parts of the system. The managing software 30 may likewise include a rendering engine 70, described later.

The digital images and video content may be stored in an archive 50. The archive 50 typically includes devices for storing the digital images and video content on a write once medium or re-writeable storage medium, such as a computer hard drive, a tape, a compact disk, a digital video disk, an optical disk, etc. In addition, multiple images and video content may be archived on the storage medium, thereby creating an archive. The managing software 30 may include a database indexing all of the digital images and video content, if desired. The database may likewise include any data for the rendering engine 70. The managing software 30 may store and retrieve digital images and video content from the archive 50.

The viewing system 60 may load or otherwise present digital images and video content for a user. The viewing system 60 may receive the digital images or video content from any part of the system, such as for example, the archive 50, the editing system 20, and the managing software 30. The images or video stored in the archive 50 may be modified by the viewing system 60 for optimized viewing, if desired. However, the viewing system 60 is preferably free from modifying the original image obtained by the viewing system 60 from the archive 50. Similarly, the image or video obtained by the viewing system 60 from the managing software 30 is preferably free from modifying the original image stored in the archive 50. Likewise, the image or video obtained by the viewing system 60 from the editing software 20 is preferably free from modifying the original image stored in the archive 50. In this manner, any modifications of the digital image or video content that may be desirable for viewing the media, are free from modifying the original image after viewing.

The browser 10 may search, load, or otherwise present digital images and video content for a user. The browser 10 may receive the digital images or video content from any part of the system, such as for example, the archive 50, the editing system 20, and the managing software 30. The images or video stored in the archive 50 may be modified by the browser 10 for optimized viewing, if desired. However, the browser 10 is preferably free from modifying the original image obtained by the browser 10 from the archive 50. Similarly, the image or video obtained by the browser 10 from the managing software 30 is preferably free from modifying the original image stored in the archive 50. Likewise, the image or video obtained by the browser 10 from the editing software 20 is preferably free from modifying the original image stored in the archive 50. In this manner, any modifications of the digital image or video content that may be desirable for viewing the media, are free from modifying the original image after viewing.

Traditional editing software is based upon obtaining an image or video from the archive (or other location), modifying the image as desired, and thereafter saving the modified image over the previous image. In this manner, the modified image or video replaces the original image or video. However, with the desirability of maintaining the image or video quality, the editing software 20 is free from modifying the content of the original image or video, such as the one stored in the archive 50, and creates a list of meta data representative of the changes to be applied to the image or video. The meta data may be any type of commands, data, or other information suitable to modify the original image. For example, the rendering engine 70 may be designed to process the meta data to render the image for other parts of the system, such as the viewing system 60 and browser 10. The meta data may be stored together with the image or video itself, a separate accompanying file, or otherwise stored in a database, such as by the managing software 30. The rendering engine 70 may likewise render an original image from the archive 50 prior to providing the image to the viewing system 60 or browser 10. In this manner, the viewing system 60 and browser 10 does not need to be modified or otherwise changed to accommodate the meta data.

Preferably the entire system is designed such that original images, such as those obtained from the capturing device 40 or stored in the archive 50, are not modified, but rather any desired changes to those original images are stored as meta data. In this manner the image and video quality may be maintained.

If a digital imaging system, including those described above and traditional ones that do not include meta data or otherwise maintain file integrity, is used to automatically maintain a list of the user's favorite digital images or video content, there exist limitations with the addition and deletion of the files from the favorites list. For example, the system may use any suitable algorithm to maintain a list of the user's most likely favorite digital images and video content. The algorithm may automatically update the list with new images and video content while simultaneously deleting older, apparently undesirable, images and video content. While such systems are useful, they have a limitation in that the system will not actually know, without user intervention, what content the user actually desires to keep. Further, interrupting the user's work flow by presenting a dialog box that must be answered yes/no each time a file is added or deleted becomes irritating to the user.

Referring to FIG. 6, to overcome the limitations associated with existing digital image and video content management system for those images most likely favorites of the user, the present inventor determined that the system should be free from altering the contents of the favorites without user intervention. Further, the system should determine, based on any suitable algorithm, when a digital image or video content may be suitable for or otherwise removed from the favorites entry folder. If an image or video content may be suitable, the present inventor determined that the intervention required by the user to add or delete should be free from interrupting the user's work flow. The intervention may take the form of a different colored icon presented to the user, which if pressed adds or deletes an image or video content from the favorites list. After the time has passed to add or remove a particular image or video content from the favorites list, the icon may resume its normal color. Further, the user may be notified by audible indications, such as a particular tone.

The terms and expressions employed in the foregoing specification are used therein as terms of description and not of limitation, and there is no intention in the use of such terms and expressions of excluding equivalents of the features shown and described or portions thereof, it being recognized that the scope of the present invention is defined and limited only by the claims that follow.

1. A digital imaging system comprising:
(a) a capturing device that obtains at least one of a digital image and a digital video in a first format;
(b) a storage device that stores said at least one of a digital image and a digital video in a file free from modification of said first format;
(c) a presentation system that presents said at least one of a digital image and a digital video to a user free from modification of said file on said storage device;
(d) an editing system that modifies said at least one of a digital image and a digital video by associating with said at least one of a digital image and a digital video meta data free from modification of the image represented by said file on said storage device; and
(e) a managing system that renders said modified at least one of a digital image and a digital video by said editing system by applying said meta data to said at least one of a digital image and a digital video to modify the appearance of said at least one of a digital image and a digital video.

2. The system of claim 1 wherein said capturing device is a digital camera.

3. The system of claim 1 wherein said capturing device is a video camera.

4. The system of claim 1 wherein said storage device is at least one of a compact disk, a hard drive, a tape, a digital video disk, and an optical disk.

5. The system of claim 1 wherein said presentation system includes a browser.

6. A method of selecting desirable images for a user comprising:
(a) maintaining a list of a plurality of desirable image content for a user that includes at least one of a digital image and a digital video;
(b) determining potential additional image content for said user that includes at least one of an additional digital image and an additional digital video;
(c) indicating to said user the potential desirability of adding said at least one of said additional digital image and said additional digital video in a manner free from interrupting the user's work flow.

7. The method of claim 6 wherein said indicating includes a visual indication.

8. The method of claim 6 wherein said indicating includes an audible indication.

9. The method of claim 1 wherein said capturing device is a stream of video.
